(19) United States
(12) Patent Application Publication
(10) Pub. No.: US 2019/0010696 A1
(43) Pub. Date: Jan. 10, 2019

(54) Insulated Panel

(71) Applicant: Building Products of Canada Corp./La Cie Materiaux de Construction BP Canada, Lasalle (CA)

(72) Inventor: Francis Bossé, Lasalle (CA)

(21) Appl. No.: 15/645,679

(22) Filed: Jul. 10, 2017

(51) Int. Cl. E04C 2/24; B29C 47/00

(52) U.S. Cl. CPC E04C 2/243; E04C 2/246; B29K 2025/06; B29K 2995/0015; B29C 47/0004

(57) ABSTRACT

A structural insulated panel includes an extruded polystyrene layer that is impermeable to both water and air and a wood-based panel to which the extruded polystyrene is attached. The insulated panel may be made of extruded polystyrene layer that is 11/16 inch thick and fibreboard of a thickness of ½ inch. The panel is reversible so as to be installable either with the extruded polystyrene panel facing outward or inward.

### TECHNICAL FIELD

The present invention relates generally to building materials and, in particular, to insulated panels.

### BACKGROUND

Insulated panels, also known as composite insulation panels or insulated sheathing, is traditionally made of a thermally insulating material such as polystyrene foam laminated on a wood fiber board. The board may be coated with asphalt for greater weather resistance. Alternatively, a vapour barrier in the form of a polymer membrane is applied. Insulated panels are attached to the outer sides of the studs of a framed house or other building structure. An exterior cladding, e.g. vinyl siding or bricks, and installed outside of the insulated panels to complete the construction. The insulated panel serves multiple functions in the wall cavity (providing insulation, an air barrier, and a vapour barrier). The insulated panel can be installed in one step, thereby saving labour costs.

Further improvements in insulated panels remain highly desirable.

### SUMMARY

The following presents a simplified summary of some aspects or embodiments of the invention in order to provide a basic understanding of the invention. This summary is not an extensive overview of the invention. It is not intended to identify key or critical elements of the invention or to delineate the scope of the invention. Its sole purpose is to present some embodiments of the invention in a simplified form as a prelude to the more detailed description that is presented later.

In general, the present invention provides a novel insulated panel having an extruded polystyrene panel attached to a fibreboard panel or other wood-based panel. The panels are bound together mechanically and/or chemically with any suitable glue or adhesive.

Accordingly, one inventive aspect of the present disclosure is an insulated panel comprising an extruded polystyrene layer that is impermeable to both water and air and a wood-based panel to which the extruded polystyrene is attached.

Another inventive aspect of the present disclosure is an insulated panel comprising an extruded polystyrene panel and a fibreboard panel laminated to the extruded polystyrene panel.

### BRIEF DESCRIPTION OF THE DRAWINGS

Further features and advantages of the present invention will become apparent from the following detailed description, taken in combination with the appended drawings in which:

FIG. 1 is an isometric view of an insulated panel in accordance with an embodiment of the present invention.

FIG. 2 is a side view of an insulated panel in accordance with an embodiment of the present invention.

It will be noted that throughout the appended drawings, like features are identified by like reference numerals.

### DETAILED DESCRIPTION

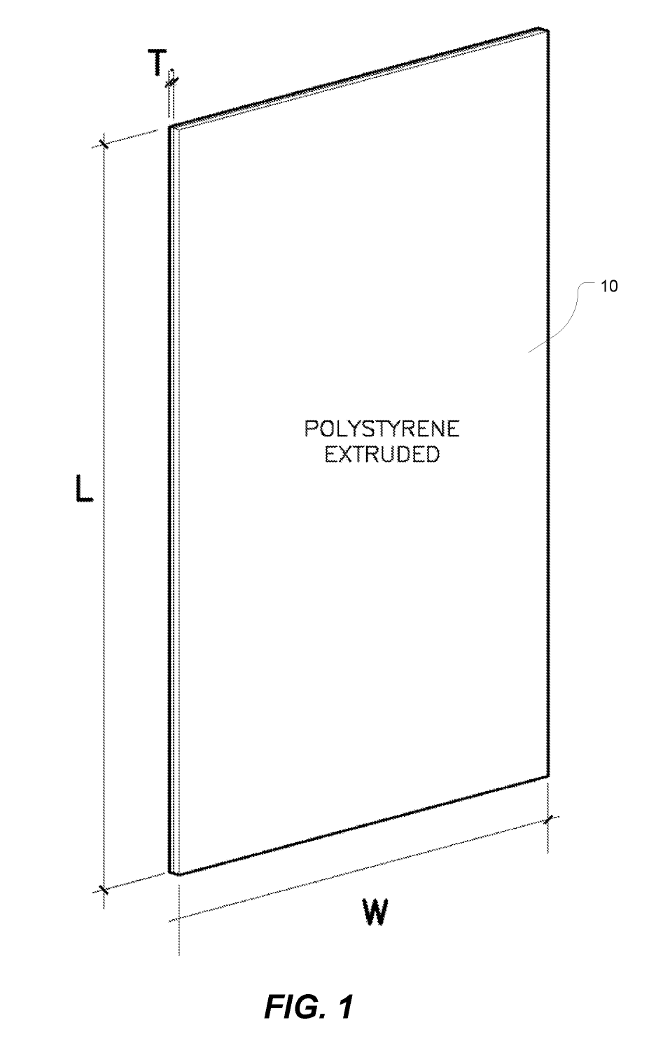

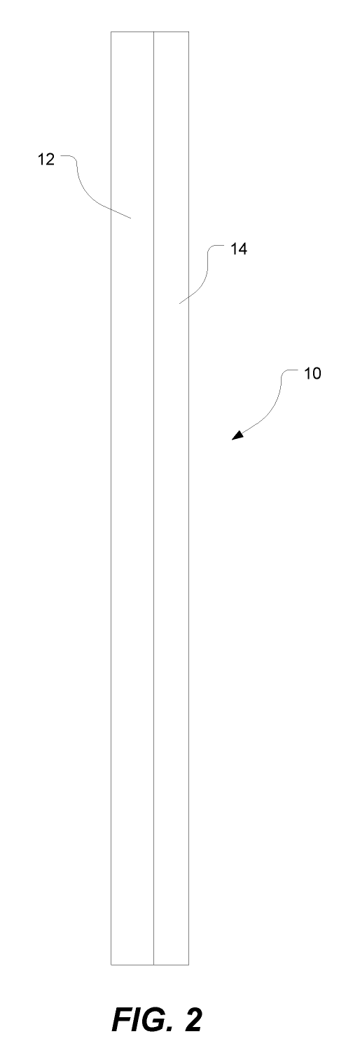

FIG. 1 and FIG. 2 depict an insulated panel 10 in accordance with an embodiment of the present invention. The insulated panel 10 includes an extruded polystyrene layer 12 (i.e. an extruded polystyrene panel). The extruded polystyrene layer is impermeable to both water and air. The insulated panel includes also a wood-based panel 14 to which the extruded polystyrene is attached. The wood-based panel may be made of fibreboard or any wood-based panel such as plywood or oriented strand board. In at least some embodiments, the fibreboard and extruded polystyrene layers are laminated together. The insulated panel may, in some instances, be considered to be a structural insulated panel, providing not only thermal insulation and a moisture barrier, but also a surface to which other building materials may be mounted, anchored or affixed.

In one specific embodiment, the extruded polystyrene layer is 11/16 inch and the fibreboard has a thickness of ½ inch. The thickness of each of the two dissimilar materials (i.e. the extruded polystyrene and the fibreboard) can be increased to meet any given insulation requirement.

The insulated panel may be rectangular as shown in FIG. 1. It will be appreciated that the insulated panel may be made of other shapes. The insulated panel may be made to industry-standard or customary dimensions of length and width, e.g. 48 inches by 108 inches. However, it will be appreciated that the insulated panel may be made to any desired or suitable length and width.

The extruded polystyrene layer may be installed such that it faces outward. Alternatively, the extruded polystyrene layer may be installed such that it faces inward.

In at least one embodiment, as depicted in FIG. 2, the extruded polystyrene panel is thicker than the fibreboard panel. In a more specific implementation, a ratio of the thickness of the extruded polystyrene panel to the thickness of the fibreboard panel is in a range of 1.7:1 to 1.1:1, more specifically in a range of 1.6:1 to 1.2:1, more specifically in a range of 1.5:1 to 1.3:1, more specifically in a range of 1.4:1 to 1.35:1. In a specific embodiment, the ratio of the thickness of the extruded polystyrene panel to the thickness of the fibreboard panel is 1.375:1. As noted above, in one specific implementation, the extruded polystyrene panel is 11/16 inch (17.46 mm) thick and the fibreboard panel is ½ inch (12.7 mm) thick. In at least some embodiments, the insulated panel consists only of the extruded polystyrene panel and the fibreboard panel such that the total thickness of the insulated panel is 1 3/16 inch (30.2 mm).

As noted above, the insulated panel is reversible so as to be installable either with the extruded polystyrene panel facing outwardly or inwardly. It is preferable though to install the extruded polystyrene panel facing outwardly. Whether it is installed with the extruded polystyrene facing inwardly or outwardly, the panel is impermeable to both water and air.

The insulated panel provides a very high level of thermal insulation, thus enabling the panel to be relatively thinner than prior-art panels of equivalent thermal insulation, i.e. to achieve the same degree of thermal insulation as a prior-art panel, the novel panel can be made thinner. Because it is thinner, the resulting panel is lightweight and easier for construction workers to install.

This invention has been described in terms of specific embodiments, implementations and configurations which are intended to be exemplary only. Persons of ordinary skill in the art will appreciate, having read this disclosure, that many obvious variations, modifications and refinements may be made without departing from the inventive concept(s) presented herein. The scope of the exclusive right sought by the Applicant(s) is therefore intended to be limited solely by the appended claims.

1. An insulated panel comprising:
an extruded polystyrene layer that is impermeable to both water and air; and
a wood-based panel to which the extruded polystyrene is attached.

2. The insulated panel of claim 1 wherein the extruded polystyrene layer is 11/16 inch.

3. The insulated panel of claim 1 wherein the wood-based panel is fibreboard of a thickness of ½ inch.

4. The insulated panel of claim 1 wherein the extruded polystyrene layer is 11/16 inch and the wood-based panel is fibreboard of a thickness of ½ inch layer faces outward.

6. The insulated panel of claim 1 wherein the extruded polystyrene layer faces inward.

7. An insulated panel comprising:
an extruded polystyrene panel; and
a fibreboard panel laminated to the extruded polystyrene panel.

8. The insulated panel of claim 7 wherein the extruded polystyrene panel is thicker than the fibreboard panel.

9. The insulated panel of claim 7 wherein a ratio of the thickness of the extruded polystyrene panel to the thickness of the fibreboard panel is 1.375:1.

10. The insulated panel of claim 7 wherein a ratio of the thickness of the extruded polystyrene panel to the thickness of the fibreboard panel is in a range of 1.4:1 to 1.35:1.

12. The insulated panel of claim 7 wherein a ratio of the thickness of the extruded polystyrene panel to the thickness of the fibreboard panel is in a range of 1.5:1 to 1.3:1.

13. The insulated panel of claim 7 wherein a ratio of the thickness of the extruded polystyrene panel to the thickness of the fibreboard panel is in a range of 1.6:1 to 1.2:1.

14. The insulated panel of claim 7 wherein a ratio of the thickness of the extruded polystyrene panel to the thickness of the fibreboard panel is in a range of 1.6:1 to 1.1:1.

15. The insulated panel of claim 7 wherein the extruded polystyrene panel is 11/16 inch thick and fibreboard panel is of ½ inch thick.

16. The insulated panel of claim 7 wherein the extruded polystyrene layer faces outward.

17. The insulated panel of claim 7 wherein the extruded polystyrene layer faces inward.

18. The insulated panel of claim 15 wherein the extruded polystyrene layer faces outward.

19. The insulated panel of claim 15 wherein the extruded polystyrene layer faces inward.

20. The insulated panel of claim 7 wherein the panel is reversible so as to be installable either with the extruded polystyrene panel facing outward or inward.
